(19) United States
(12) Patent Application Publication
(10) Pub. No.: US 2004/0122685 A1
(43) Pub. Date: Jun. 24, 2004

(54) Verification system for facilitating transactions via communication networks, and associated method

(76) Inventor: Daryl Bunce, Seattle, WA (US)

Correspondence Address: PERKINS COIE LLP/AWS, P.O. BOX 1247, SEATTLE, WA, 98111-1247, US

(21) Appl. No.: 10/325,408

(22) Filed: Dec. 20, 2002

(51) Int. Cl. G06F 17/60

(52) U.S. Cl. 705/1; 705/44

(57) ABSTRACT

A system and related method for use in facilitating transactions in communication networks is provided. The system includes a mobile device configured to send and receive information over a wireless communication network. The mobile device may include a short-range wireless facility. A service provider subsystem may process identity verification requests and otherwise facilitate transactions between a mobile device user and a seller of items or services. Verification and/or facilitation functions may begin with a request from a mobile device to purchase an item or service from a seller. The request may include information identifying a user of the mobile device. Based on this information, the service provider may verify the identity of the user. An indication of this verification may be sent to the mobile device and/or the seller using a network connection. Using similar techniques, other transaction-related functions may be performed, including billing/credit card functions, delivery functions, etc.

### TECHNICAL FIELD

The following disclosure relates generally to network communication at multiple access points, and more particularly to verification and transaction techniques involving mobile devices.

### BACKGROUND

In typical customer/merchant transactions, a customer will enter a store or sales facility and select items or services for purchase. When the customer is ready to make a purchase, the customer interacts with a merchant or vendor, and sometimes a credit card company or another third party financial service provider, to tender payment. Payment typically occurs using cash, checks or credit cards. Customer/merchant transactions often require the presence of a cashier or other employee, although automated check-out systems are also utilized in some circumstances.

When making such purchases, positive identification of the customer and/or the merchant may be desirable to prevent fraudulent transactions and purchase disputes. This is especially true in the case of rental transactions (e.g. equipment, video or DVD rentals) or when the customer is purchasing unique or large-ticket items. Positive identification of a customer is also useful in the case where the customer is interested in conducting a trial of an item before purchase, such as when test-riding a bicycle. Conventional point-of-purchase identification techniques geared toward identifying the customer typically involve requesting a customer's picture identification, such as a driver's license. The practice of attempting to verify the identity of the merchant is not as common, but not unheard of. In many situations, customers merely assume that they are purchasing from a legitimate and reputable establishment or individual.

### BRIEF DESCRIPTION OF THE DRAWINGS

FIG. 1 is a block diagram of a suitable system for employing a verification system under embodiments of the invention.

FIG. 2 is a block diagram of a suitable mobile device for initiating and confirming a transaction between a customer and a merchant.

FIG. 3 is a block diagram of a suitable merchant subsystem for facilitating a transaction involving verifying the identity of at least one party to the transaction.

FIG. 4 is a flow diagram showing an example of communication data between the blocks shown in FIG. 1.

FIG. 5 is a flow diagram showing an alternate example of communication data between the blocks shown in FIG. 1.

FIG. 6 is a flow diagram of an example routine for placing an order for an item via the mobile device of FIG. 2.

FIG. 7 is a flow diagram of an example routine performed by the merchant subsystem of FIG. 3 for requesting and receiving verification of a customer's identity.

FIG. 8 is a flow diagram of an example routine performed by the mobile device of FIG. 2 for requesting and receiving verification of a customer's identity.

FIG. 9 is a flow diagram of an example routine performed by the service provider subsystem of FIG. 1 to verify a customer's identity.

FIG. 10 is a flow diagram of an example routine performed by the service provider subsystem of FIG. 1 to verify a customer's identity and perform other transaction-related tasks.

The headings provided herein are for convenience only and do not necessarily affect the scope or meaning of the claimed invention.

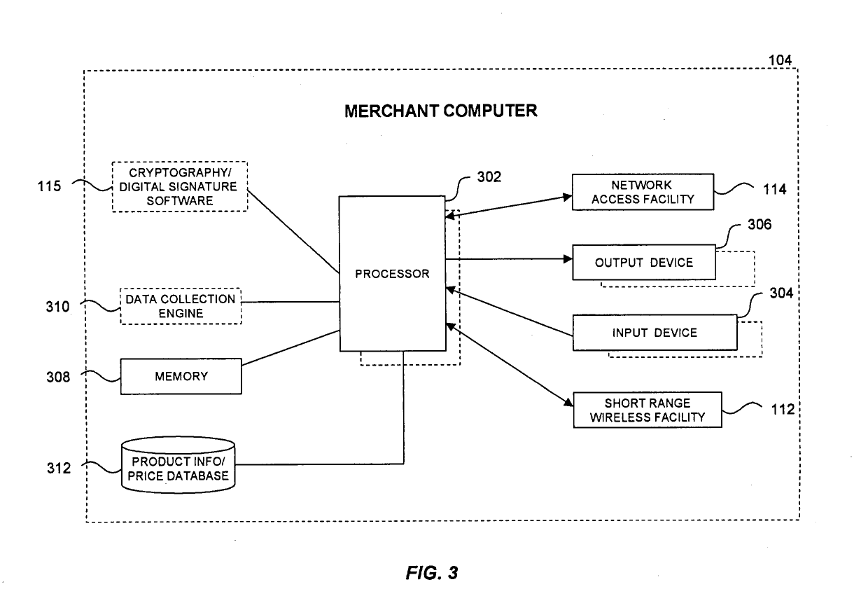

In the drawings, the same reference numbers identify identical or substantially similar elements or acts. To easily identify the discussion of any particular element or act, the most significant digit or digits in a reference number refer to the figure number in which that element is first introduced (e.g., block 302 is first introduced and discussed with respect to FIG. 3).

### DETAILED DESCRIPTION

Described in detail below is a system and associated method that allows a customer to engage in sales transactions with a person, such as a seller, merchant or vendor using a mobile device, such as a cellular phone, in a manner such that various transaction-related functions may be facilitated by a service provider for the mobile device (e.g., a wireless service provider or carrier). Such functions can include, among other things, verifying the identities of any of the customer and the seller, merchant or vendor. For example, a customer may walk into a store or other establishment wishing to test and ultimately purchase an item, such as an automobile, or a service, such as windshield repair. While browsing through the store, the customer may obtain information (e.g., price and item specification information) about the various items or services offered by having a seller-operated system (e.g., a networked computing device) transmit the information directly to the customer's mobile device. The transmission of this information may occur using, for example, a short-range wireless communication technique (e.g., infrared, Bluetooth or IEEE 802.11).

When the customer decides that she would like to test or purchase an item, she provides an indication (e.g., a purchase request or purchase order) to the seller. This indication may be communicated to the seller-operated system via the customer's mobile device. After receiving this indication, the seller may request to have the customer's service provider verify the customer's identity and/or purchasing ability. Similarly, the customer may request to have the service provider verify the seller's identity and/or business reputation. The wireless service provider performs these verifications as a “trusted network,” in that it is difficult for someone to transmit false data. The flow of the verification process may vary, but the ultimate outcome is that each party may receive verification of the other's identity so that they can proceed with the transaction. The verification process itself may include authenticating a digital signature or the like.

In addition to verifying the identity of the customer, the service provider in some embodiments may perform other transaction-related functions. For example, the service provider may verify that the customer is twenty-one years old or verify the address of the customer. The service provider may also verify or validate the location of the mobile device to protect against fraudulent transactions. Similarly, the service provider may provide digitally signed time stamps to verify that a transaction occurred at a certain time. In some embodiments, the service provider may do even more, such as oversee delivery of an item to the customer or verify or handle credit card authorizations or credit checks involving a third party financial service provider. As an alternative to involving a third party financial service provider in a transaction, the customer's mobile account may be billed for the transaction. Using the service provider as the transaction facilitator under such a system provides various benefits. For example, this system allows the customer to limit the amount of personal information provided to the merchant while providing assurance to both parties that the transaction is legitimate and verifiable.

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

Representative System

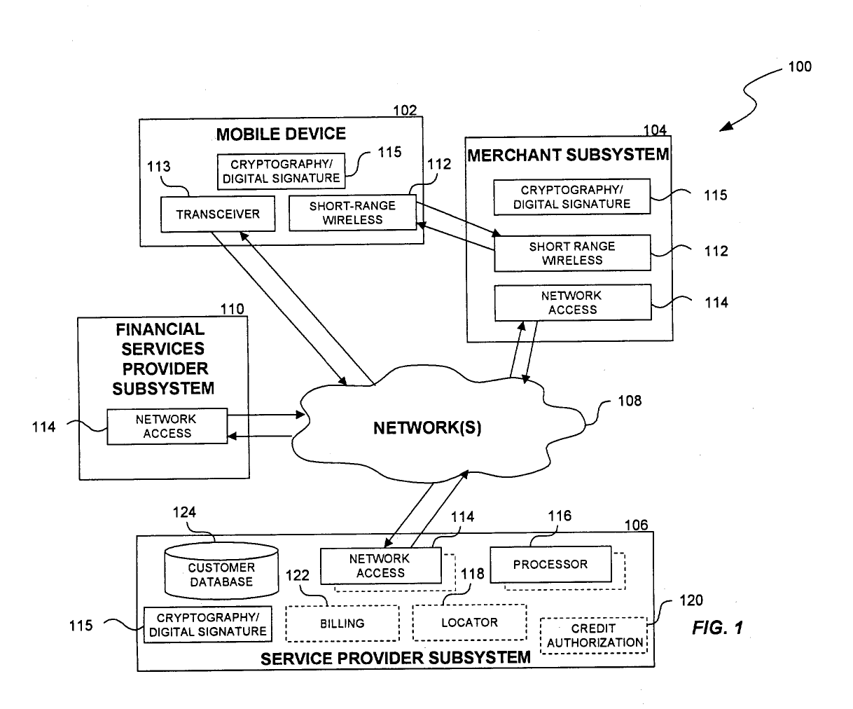

Referring to FIG. 1, a system 100 that facilitates network communications between a mobile device 102, a merchant subsystem 104, a mobile service provider subsystem 106, and (optionally) a financial service provider subsystem 110 is illustrated. These communications may take place via a network 108, which can be a wireless network (e.g., a GSM, CDMA, IS-136, analog, or other cellular network) and/or a wired network, such as the Internet, a wired LAN (local area network), or even a public switched telephone network (PSTN). If a cellular wireless network is utilized, various cellular wireless communication techniques may be used such as CDPD (Cellular Digital Packet Data), GPRS (General Packet Radio Service), EDGE (Enhanced Data rates for GSM Evolution), or CSD (Circuit Switched Cellular Data). Accordingly, the merchant subsystem 104, the service provider subsystem 106 and the financial service provider subsystem 110 include a network access facility 114.

Additionally, the system facilitates short-range wireless communications (e.g., Bluetooth, Infrared, etc.) between the mobile device 102 and the merchant subsystem 104. Bluetooth, a specific example of a short-range wireless communication technique, operates using frequency-hopping spread spectrum, where data packets are spread across the 2.45 GHz Spectrum at a rate of 1,600 hops per second to lessen interference. The nominal link range is 10 meters, and the gross data rate is 10 Mbps, although increases may be possible. Bluetooth can support both synchronous connection oriented (“SCO”) links for voice and asynchronous connectionless (“ACL”) links for packet data. While aspects of the invention are described herein as employing the Bluetooth protocol or infrared, those skilled in the relevant art will recognize that aspects of the invention are equally applicable with other wireless communication protocols and standards, including IEEE 802.11, IEEE 802.11b, Home RF, contactless smart cards, IrDA standards, etc.

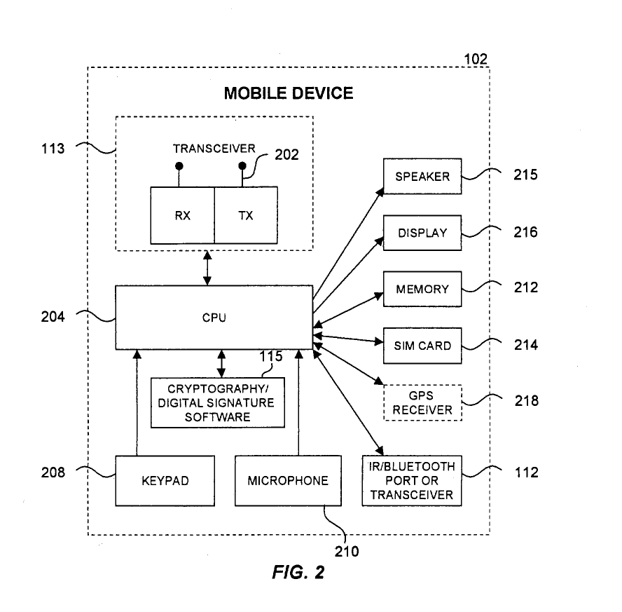

To facilitate communication via short-range communication techniques, both the mobile device 102 and the merchant subsystem 104 may include a short-range wireless facility 112, including components such as an input/output port or transceiver and the necessary hardware and software, not shown, but well-known in the art. Additionally, the mobile device 102 may include a transceiver 113 for communication via the wireless network 108. Additional components of the mobile device 102 and the merchant subsystem 104 are illustrated and described in FIGS. 2 and 3 respectively.

The mobile device 102, the merchant subsystem 104 and the service provider subsystem 106 may include cryptography and/or digital signature software 115. Although not illustrated, the third party financial service provider subsystem 110 may also include similar software. This software may be used to ensure that information being sent over one or more networks 108 is secure and that the source of the information can be verified. For example, in a public key cryptography system (well known in the art), encrypted communications can only be decrypted using a key uniquely associated with the sender of the communication. Thus, where a sender's unique public key can effectively be used to decrypt the sent communication, the sender's identity is verified. In accordance with the present invention, techniques involving cryptography may also be utilized to help ensure that any information transmitted between parties remains secure when transmitted over an insecure network 108. For example, the service provider subsystem 106 may receive from the mobile device 102 or merchant subsystem 104 an encrypted purchase order digitally signed by the customer and/or merchant. The service provider subsystem 106 may then use this communication in conjunction with a customer database 124 to verify the customer's identity and/or the merchant's identity. After the verification is complete, the service provider subsystem 106 sends sensitive customer information back to the merchant subsystem 104 and/or mobile device 102, using encryption to protect the sensitive information and to authenticate its source.

As a hub for transactions between parties, the service provider subsystem 106 in the illustrated embodiment may include one or more processors 116, a mobile device locator subsystem 118, a credit authorization subsystem 120, a billing subsystem 122, and a customer database 124.

The customer database 124 stores entries for each customer that subscribes to one or more of the services provided by the service provider subsystem 106. Different levels of information may be provided for each customer, depending on the types of services desired. For example, customers requesting basic mobile service may provide only name, phone number, and address information (for billing purposes) while customers requesting enhanced services (e.g., transaction facilitation capabilities) may provide additional information (e.g., credit card information, social security number, delivery information, account charging preferences, etc). The customer authorizes the extent and manner in which the provided information can be used by the service provider subsystem 106 and passed on to third parties. This authorization information is also stored in the customer database 124. The service provider subsystem 106 can obtain the appropriate customer information at the time when the customer initially purchases the mobile device 102 or when the customer purchases network access from the service provider. At the time of purchase, the customer can create a digital signature, a public/private key pair or session key, a pseudonym, etc. This data can be stored in the device. During this initial registration phase, the customer information (e.g., name, address, credit card information, etc.) is provided to the service provider subsystem 106 and linked to the digital signature or other identification key. In this way, the service provider 106 becomes an authentication authority for future transactions.

The phone locator subsystem 118 provides latitude and longitude information about the cell site to which a mobile device 102 is connected. Alternatively, the phone locator subsystem 118 can provide the latitude and longitude or other positional coordinates of a mobile device 102 within the cell site. Further details on the locator subsystem 118 may be found in U.S. Patent Application No. 60/388,942. The particular mobile device 102 may itself be identified using a mobile identification number (MIN), an international mobile equipment identifier (IMEI), an international mobile station identifier (IMSI) or any other sufficiently unique identifier known to those skilled in the relevant art. In this way, the service provider subsystem 106 can locate mobile devices 102 for verification purposes during a transaction or for other transaction-related purposes. Using techniques such as caller ID, cookies, digital signatures, etc., the location of the merchant or store can be verified if communications between the merchant subsystem 104 and the service provider subsystem 106 occur.

In some embodiments, the customer registered to the mobile device 102 may pre-authorize certain transactions facilitated via the mobile device 102, provided that the mobile device 102 is located in a certain geographical area, or the transaction occurs with a specified time period. In this way, the customer can prevent certain unauthorized transactions by other users, while allowing these users to use the mobile device 102 to conduct certain authorized transactions. For example, the customer may authorize his or her children to use the mobile device 102 to facilitate transactions at certain locations (the neighborhood video rental store or grocery store) but not at other locations. At the same time, a thief that steals the mobile device 102 will not be authorized to transact using the mobile device 102.

The billing subsystem 122 allows the service provider subsystem 106 to bill customers for the typical services provided, such as use of a cell phone network. In accordance with one embodiment of the invention, the billing subsystem 122 may also allow the service provider subsystem 106 to bill the customer for sales transactions authorized by the customer. For example, when a customer wishes to purchase an item from a merchant using the mobile device 102, the service provider 106 may, in addition to verifying the identity of the customer, act as a financial service provider and credit the account of the merchant. The service provider 106 may then assemble and forward charges to be billed to the customer at the end of the billing period. The customer, in turn, pays the service provider 106 either the entire balance or in monthly installments with interest.

Even if the service provider 106 does not function as a financial service provider, the credit authorization subsystem 120 may allow the service provider 106 to request, for example, credit card authorizations from third-party financial service providers 110 (such as credit card companies or other lenders) in the name of the customer (e.g., credit card number or information necessary to perform a credit check). Accordingly, the customer does not have to provide any financial information to the merchant in order to complete a transaction. The customer does not even have to carry a credit card. Likewise, the merchant does not have to worry about fraudulent credit card transactions. Moreover, because direct payment is not required, the parties to the transaction may not need to reveal their identities to each other.

FIG. 2 shows a block diagram of a typical mobile communication device 102 such as a mobile handset. In addition to the components described with respect to FIG. 1, the mobile communication device 102 has one or more internal or external antennas 202 for receiving and transmitting electromagnetic signals such as radio frequency signals. The transceiver 113 is connected to the antenna 202 and typically provides modulation and demodulation of the transmitted and received signals, respectively. A processor unit 204 connected to the transceiver 113 may comprise a signal processor, microprocessor, ASIC, or other control and processing logic circuitry. The processor unit 204 may perform signal coding, data processing, input/output processing, power control, and other functions necessary for implementing a mobile communication device. A customer might provide input to the processor unit 204 via a keypad 208, microphone 210, or display/touchpad 216. In turn, the processor 206 might provide information to the customer via the display/touchpad 216 or a speaker 215.

The processor 204 may access information from, and store information in, a non-removable memory 212 or a removable memory 214. The non-removable memory 212 may consist of RAM, ROM, a hard disk, or other well-known memory storage technologies. The removable memory 214 may consist of Subscriber Identity Module (SIM) cards, which are well known in GSM communication systems, or other well-known memory storage technologies, such as “smart cards.” Applications such as digital signature/cryptography software (described in greater detail in the text accompanying FIG. 1) could be implemented in either removable memory 214 or non-removable memory 212. Personal and/financial information can also be stored in either removable memory 214 or non-removable memory 212 so that systems that do not have immediate access to the same communication channels as the mobile device can receive this information. A password or other security facility may be implemented to limit access to sensitive information stored in removable memory 214 or non-removable memory 212, such as the customer's digital signature, public/private key pair, pseudonym, etc.

The mobile communication device 102 may include an optional GPS chipset or receiver 218 that provides latitude and longitude information about the mobile device's 102 current location. This allows the service provider subsystem 106 to locate the mobile device 102 when appropriate.

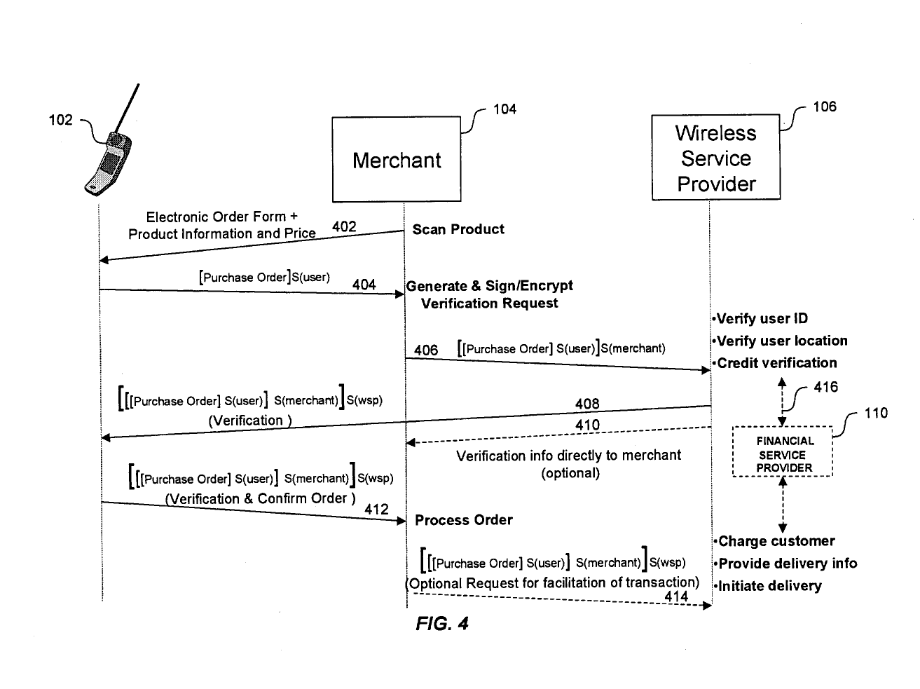

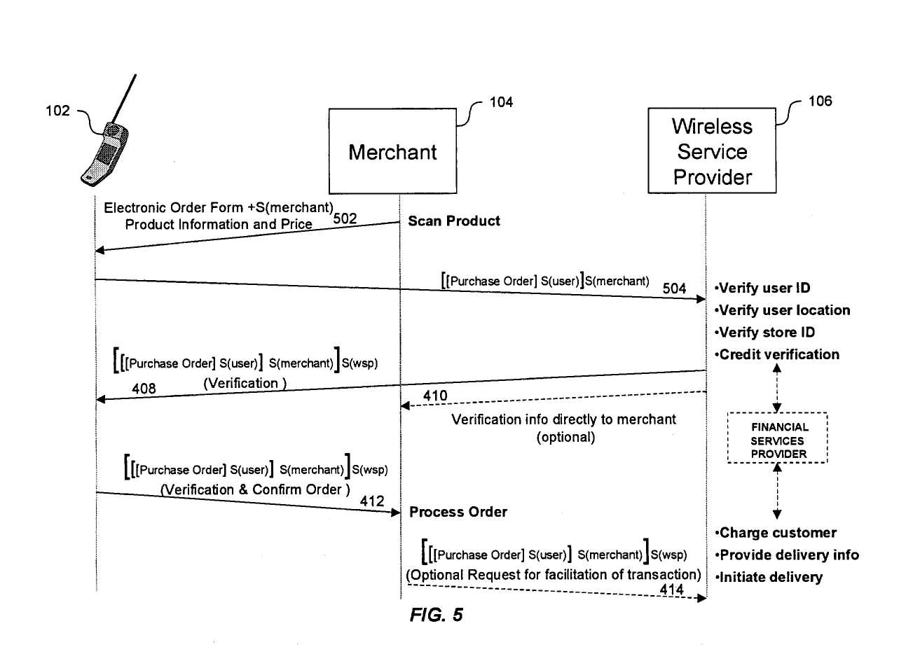

While a mobile phone is shown as the mobile communication device 102 in the embodiments illustrated in FIGS. 4 and 5, those skilled in the relevant art will appreciate that the invention can be practiced with other devices and configurations, including Internet appliances, hand-held devices, wearable computers, multi-processor systems, microprocessor-based or programmable consumer electronics, set-top boxes, PDA's (Personal Digital Assistants), portable laptop computers, and the like. The term “mobile device” is intended to include all such devices.

FIG. 3 shows a block diagram of a typical merchant subsystem 104. The merchant subsystem 104 can be embodied in a general purpose computer or data processor specifically programmed, configured or constructed to perform one or more of the computer-executable instructions explained in detail below. Indeed, the term “computer” or “wireless device,” as used generally herein, may refer to any of the above devices and systems, as well as any data processor. In addition to the components described with respect to FIG. 1, the merchant subsystem 104 in the illustrated embodiment also includes one or more processors 302, input devices 304 (e.g., keyboard, mouse, etc.), output devices 306 (e.g., display screen) and memory 308. A database 312 may store product and inventory information and in some cases customer information.

In some embodiments, a specialized input device or facility 310 for automated data entry is also provided, such as a data collection engine or imager module, which allows the merchant subsystem 104 to automatically collect data from data carriers such as bar codes, magnetic stripes, radio frequency identification tags (RFID tags), etc. These types of data carriers are especially useful for placement on items in the merchant's inventory. The data collection engine module 310 may take the form of any data collection device, such as a laser scanner, wand-type bar code reader, magnetic stripe reader, RFID reader, and like. The data collection engine module 310 may also be a two-dimensional imager, such as a CCD camera. Using the data collection engine 310, the merchant subsystem 104 can, for example, read bar codes associated with items that the merchant is offering for sale and then provide this information to customers or input it into the database 312. In some embodiments, the data collection engine 310 may be used to read data provided from other sources, such as from a customer's mobile device 102. For example, the data collection engine may be able to read customer identification data or a confirmation number displayed (e.g., in the form of a bar code) on the customer's mobile device 102.

Representative Flows

Referring to FIGS. 4 and 5, representative message or data flow diagrams depict exchanges of communications between the mobile device 102, the merchant subsystem 104, the service provider subsystem 106, and optionally, the financial service provider subsystem 110. These and other flow diagrams do not show all functions or exchanges of data, but instead provide an understanding of commands and data exchanged under the system. Of course, those skilled in the relevant art will recognize that some functions or exchange of commands and data may be repeated, and other (less important) aspects not shown may be readily implemented.

FIG. 4 is an example of a message or communications flow for verifying the identity of a customer during a transaction between a customer and a merchant. In an optional communication 402, the merchant subsystem 104 communicates to the customer's handset 102 information about a product such as the product's price or an electronic order form. In some embodiments, this information may be scanned or inputted into the merchant subsystem 104 using a scanner or other data collection module 310 device. The merchant subsystem 104 may then transmit the product information to the customer's handset 102 using the short-range communication facility 112 such as Bluetooth or infrared technology. Once the handset 102 is in receipt of the product information, in a communication 404, the short-range wireless facility 112 of the handset 102 communicates back to the merchant subsystem 104 an electronic purchase order designating the product or item that the customer wishes to purchase. In the illustrated embodiment, the customer digitally signs this purchase order using his or her handset so that the service provider 106, the merchant 104 or both, can verify the identity of the customer using this digital signature. In some embodiments, some or all of the information in the communication 404 may be encrypted using a private key such as that used with a public key cryptography system.

In a communication 406, the network access facility 114 of the merchant subsystem 104 sends to the service provider 106 the purchase order signed digitally by the customer with an indication of the merchant's identity, which may be a digital signature of the merchant. The communication 406 could be via a cell phone, a TCP/IP session, a PSTN call, an instant message, an email message, an SMS message, etc. Once the service provider receives the communication 406, the service provider 106 may perform one or more of the following functions including: verifying the customer's identity based on the customer's digital signature; verifying the customer's location; performing a credit card account authorization; etc. If a credit authorization takes place, an additional communication 416 over the network 108 between the service provider 106 and a financial service provider 110 may be involved.

In a communication 408, the service provider 106 sends to the customer's handset 102 the purchase order information that was originally digitally signed by the customer and the merchant. The communication 408 may be made over the wireless network 108 in the form of an instant message, text message, voice message, SMS message, etc. In the illustrated embodiment, the purchase order includes the signature of the service provider 106, thus providing additional confirmation that the verification has occurred. The service provider 106 may append additional information to the purchase order, such as various details about the services performed by the service provider subsystem 106, data regarding the customer (as stored in the database 124), the service provider's digital signature, etc. The information contained in the communication 408 may also be transmitted to the merchant subsystem 104 as well as the handset 102, shown as a dashed line (a communication 410).

The communications 410 and 408 may be made via a network connection 108 such as a wireless network or the Internet. In some embodiments, these communications may be made via a short-range wireless connection, such as 802.11. The communication 410 could also be an automated call over the PSTN to the merchant's phone. In a communication 412, the customer confirms the order by sending the digitally signed and verified purchase order from the handset 102 to the merchant subsystem 104 via the short-range wireless facility 112 so that the merchant may process the order. At this point, the customer may identify additional transaction services he or she wants the service provider 106 to perform such as charging the transaction, providing delivery information if necessary and/or initiating delivery of the product. Accordingly, the merchant and/or customer may send an optional communication 414 requesting facilitation of the transaction by the service provider 106 to the extent requested by the customer.

FIG. 5 is an example of a message flow for verifying a customer's identity during a sales transaction in an alternate embodiment of the invention where it is the customer rather than the merchant that originally requests the verification by the wireless service provider 106. In this alternate embodiment, a communication 502 transmitting product information from the merchant subsystem 104 to the handset 102 is similar to the communication 402 of FIG. 4. However, the digital signature of the merchant may be included in the communication 502. Including the digital signature of the merchant in the communication 502 later allows the service provider 106 to verify the identity of the merchant as well as that of the customer. In the illustrated embodiment, the communication 502 may be made via the short-range communication facilities 112.

In a communication 504, the handset 102 transmits to the service provider 106 the purchase order digitally signed by the customer and the merchant. The communication 504 between the handset 102 and the service provider may be made via the wireless communication network 108. Using the information transmitted in the communication 504, the service provider 106 may verify the customer identification, verify the customer's location, verify the store's identification and perhaps perform credit verification if requested by the customer. In the communication 408, and the optional communication 410, information regarding the verification is sent from the wireless service provider to the customer's handset 102 and (optionally) to the merchant subsystem 104.

As with the message flow of FIG. 4, the message flow of FIG. 5 may include the communication 412 where the customer confirms the order by sending the verification information/order confirmation from the handset 102 to the merchant subsystem 104. At this point, the merchant may proceed with processing the order. If requested by the customer, this may include sending an additional communication 414 to the service provider 106 requesting facilitation of the transaction (e.g., providing account information, charging the customer, providing delivery information, initiating delivery, etc.).

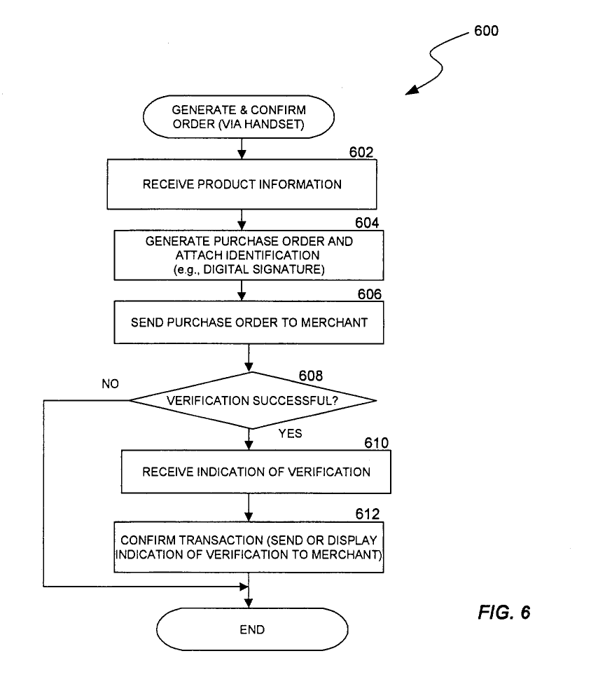

Referring to FIGS. 6 through 10, some functionality performed by the system is shown as one or more routines. These routines may be hardware-based, embodied in software in a computer-readable medium, or any combination of the two. FIG. 6 is an example of a routine 600 performed by the mobile device 102 to generate and confirm the purchase of an item from a merchant under the flow of FIG. 4. In block 602, the handset 102 receives product information from the merchant subsystem 104. This may be done via the short-range wireless techniques noted above. Various examples of some of the information that may be transmitted include product description information, product price, ordering instructions, merchant's digital signature, etc.

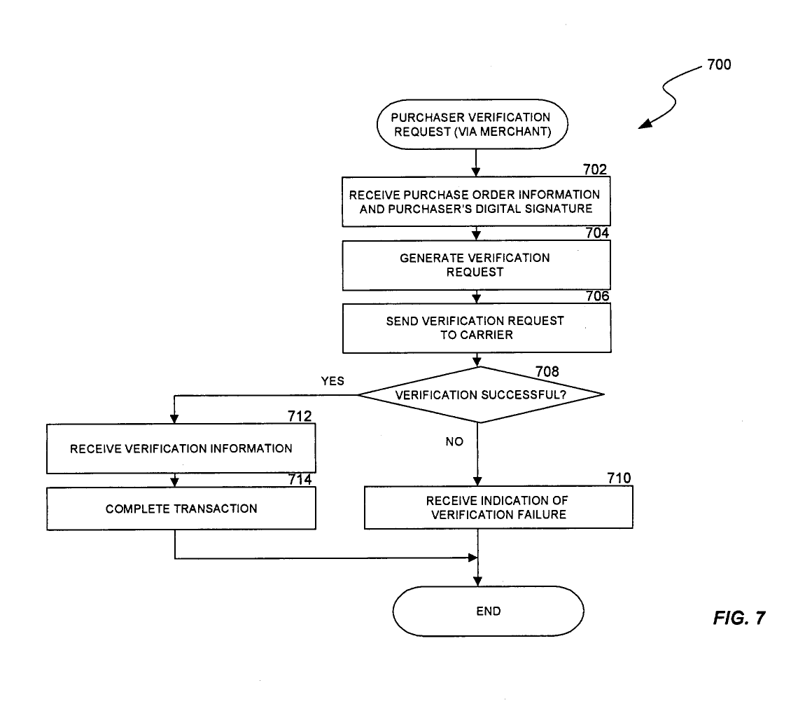

In block 604, the handset 102 generates a purchase order and attaches the customer's personal identification indication (e.g., name, user ID, alias, phone number, MIN, digital signature, etc.) to the purchase order. In block 606, the handset 102 sends the purchase order with the attached identification indication to the merchant subsystem 104. As with the initial transmission received from the merchant subsystem 104, this transmission may be done via a short-range transmission. At this point, the merchant subsystem 104 begins a verification routine (see the purchase verification request routine 700 of FIG. 7). In decision block 608, the handset 102 waits for a verification. If the verification is ultimately unsuccessful, the routine in the handset 102 ends. If, however, in decision block 608 the verification is successful, the routine continues at block 610 where the handset 102 receives an indication of this verification. This indication may be received either directly from the service provider 106 or may be received from the merchant who in turn received it from the service provider 106. In block 612 the handset 102 sends or displays the indication of the verification to the merchant in confirmation. The routine then ends.

FIG. 7 is an example routine 700 performed by a merchant subsystem 104 to request verification of a customer's identity under the flow of FIG. 4. Beginning in block 702, the merchant subsystem 104 receives from the customer's handset 102 purchase order information along with the customer's digital signature or other identification. In block 704, the merchant subsystem 104 generates a verification request to send to the service provider 106. In block 706, the verification request is sent to the service provider 106. If, in decision block 708, the verification by the service provider 106 is unsuccessful, the routine continues at block 710 where the merchant subsystem 104 receives an indication of verification failure. After block 710, the routine ends. If, however, in decision block 708 the verification is successful, the routine continues at block 712 where the merchant subsystem 104 receives the verification information. The routine then continues at block 714 where the merchant subsystem 104 performs the steps necessary to complete the transaction. After block 714, the routine then ends. In the illustrated verification request routine 700, the merchant subsystem 104 communicates to the handset 102 via a short-range communication technique and communicates to the service provider 106 via a network communication such as the Internet or a wired or wireless telephone network.

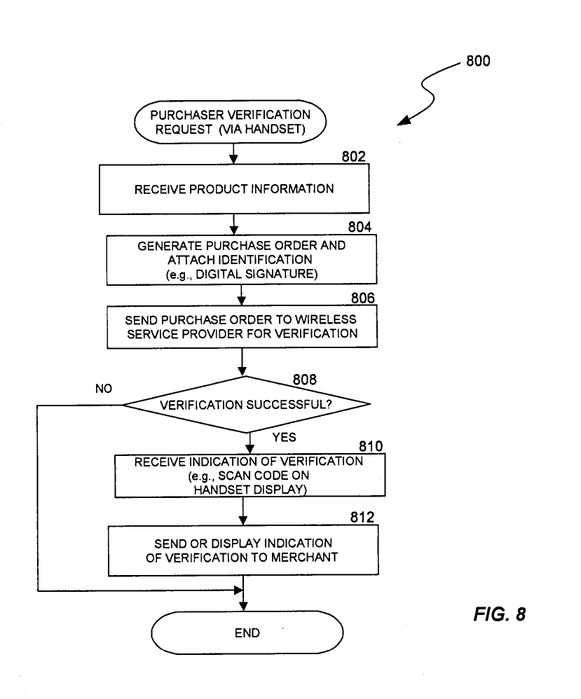

FIG. 8 is an illustration of an alternate example routine for requesting verification of a customer's identity under the flow of FIG. 5. In the illustrated embodiment, the routine 800 is performed by the customer's handset 102. Beginning with block 802, the handset 102 receives product information from the merchant subsystem 104, which may be in the form of an order form. The routine then continues at block 804 where the handset 102 completes the order form and attaches an indication of the customer's identity, such as a digital signature. In block 806, the handset 102 sends the digitally signed purchase order to the service provider 106 for verification. In this illustrated alternate embodiment, the handset 102 does not send the purchase order to the merchant subsystem 104. However, the exclusion of this step may not occur in other embodiments. In decision block 808, the handset 102 waits for a response from the service provider 106. If the verification is unsuccessful, the routine ends. If, however, in decision block 808 the verification is successful, the routine continues at block 810 where the handset 102 receives an indication of the verification. For example, the handset 102 may receive a scan code or some other message that the handset 102 can display on its display screen or send to the merchant subsystem 104 in order to confirm the order. In block 812, the routine sends or displays the indication of the verification to the merchant subsystem 104. If the indication is sent to the merchant subsystem 104, the transmission may occur via a short-range communication technique. The routine then ends.

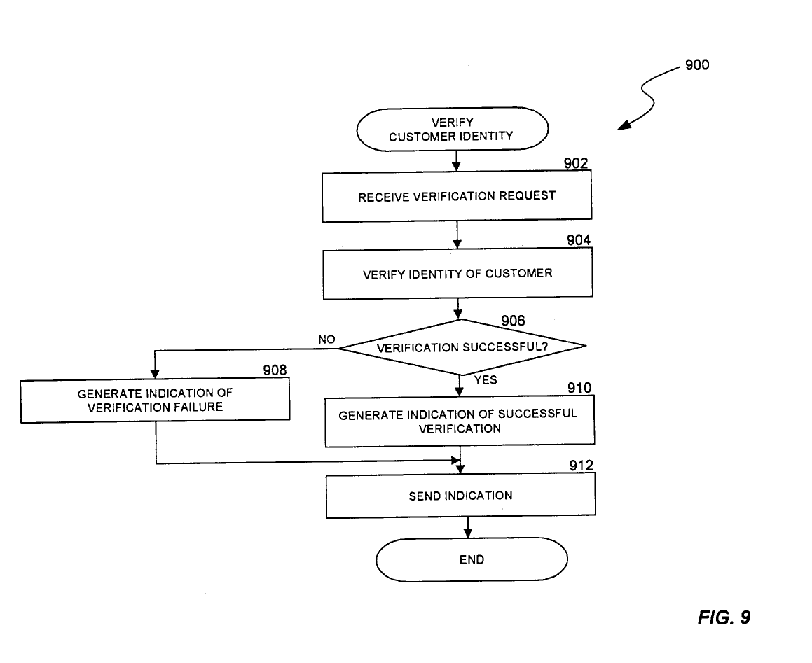

FIG. 9 is an illustration of an example routine 900 where the service provider 106 verifies the customer's identity in response to a request for identity verification sent to the service provider 106 via either the handset 102 or the merchant subsystem 104 under the flow of FIG. 5. Beginning with block 902, the routine receives a verification request from either the handset 102 or the merchant subsystem 104. In block 904 the identity of the customer and/or the vendor is verified. This may be done by checking, for example, a digital signature or other hash code provided by the customer against a database of customer information. In decision block 906, if the verification is unsuccessful, the routine continues at block 910 where an indication of the verification failure is generated. If, however, in decision block 906 the verification is successful, the routine continues at block 908 where an indication of a successful verification is generated. In block 912, the indication of either successful or unsuccessful verification is sent to the handset 102 and/or the merchant subsystem 104. The routine then ends.

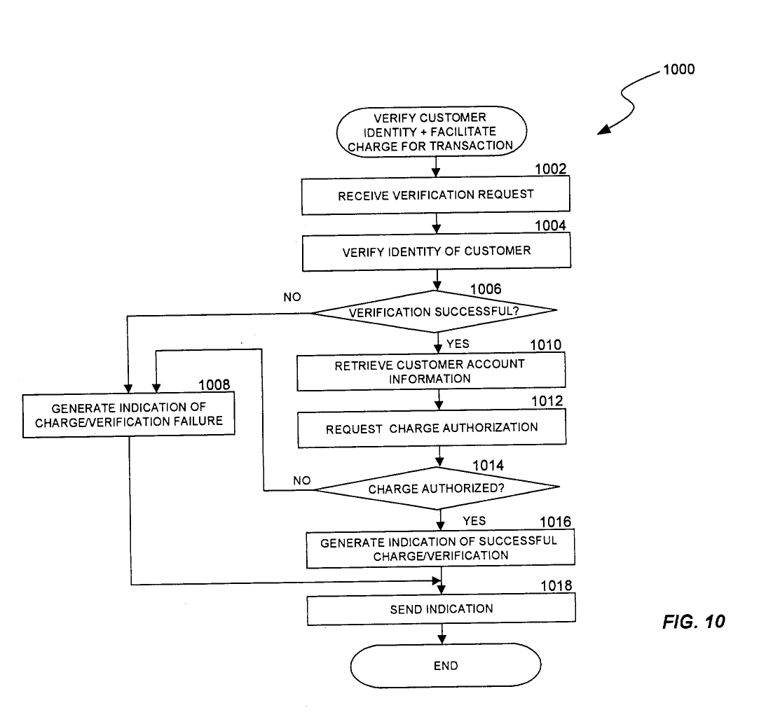

FIG. 10 is an illustration of an example routine 1000 performed by a service provider 106, where the service provider 106 performs multiple transaction-related services as requested by the customer and/or merchant. Beginning in block 1002, the service provider 106 receives a verification request from either the handset 102 or the merchant subsystem 104. In block 1004, the routine verifies the identity of the customer and/or the location of the mobile device 102. The location of the merchant 104 may also be verified in block 1004. In decision block 1006, if the verification is unsuccessful, the routine continues at block 1008 where the routine generates an indication of the verification failure. The routine then continues at block 1018 where the indication of failure is sent to either the handset 102 or the merchant subsystem 104. If, however, in decision block 1006 the verification is successful, the routine continues at block 1010 where the service provider 106 retrieves customer account information from a customer database. In block 1012, the routine requests a charge authorization from a third party financial service provider such as a credit card company. In decision block 1014, if the charge is not authorized the routine moves back to block 1008 where the service provider 106 generates an indication of such failure. If, however, the charge is authorized, the routine continues at block 1016 where the service provider 106 generates an indication of successful charge and verification. The routine then continues at block 1018 where the indication is sent to either the merchant subsystem 104 or the handset 102. After block 1018 the routine ends.

A service-provider providing the functionality described above may derive revenue based on various subscriber fees. For example, merchants may be willing to pay a monthly or per transaction fee to reduce fraudulent transactions and provide for quick and easy sales. Alternatively, or additionally, the service provider may provide functionality to customers on a subscription basis. For example, the service provider may provide premium content or features (e.g., easy vendor verification and auto-charge features) to customers at higher rates beyond simple subscription fees for a mobile plan. Credit providers or financial institutions that issue bank cards or finance sales transactions may also pay a per transaction fee.

Unless the context clearly requires otherwise, throughout the description and the claims, the words “comprise,” “comprising,” and the like are to be construed in an inclusive sense as opposed to an exclusive or exhaustive sense, that is to say, in the sense of “including, but not limited to.” Words using the singular or plural number also include the plural or singular number, respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not necessarily the wireless telephone system described in detail herein. These and other changes can be made to the invention in light of the detailed description. Moreover, the elements and acts of the various embodiments described above can be combined to provide further embodiments.

In general, the terms used in the following claims should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium (e.g., RAM or ROM memory, CD-ROM, DVD, hard drive, etc.), other aspects may likewise be embodied in a computer-readable medium. Accordingly, the inventors reserve the right to add additional claims after filing the application to pursue such additional claim forms for other aspects of the invention.

I claim:

1. A system for facilitating sales transactions using at least one communication network, the system comprising:
a mobile device comprising:
a wireless transceiver configured to send and receive information over a wireless communication network;
a mobile short-range wireless facility configured to send and receive verification request information, the verification request information including information related to a desired transaction;
a merchant subsystem comprising:
a merchant short-range wireless facility configured to receive the verification request information from the mobile device;
a merchant network access facility configured to send the verification request information over the communication network; and
a service provider subsystem comprising:
a customer database containing information associated with one or more users, wherein one of the one or more users is a user of the mobile device; and
a service provider network access facility configured to receive, via the at least one communication network, the verification request information from the merchant subsystem,
a processor configured to process at least one identity verification request based on the received verification request information, wherein the processor is coupled with the customer database and the service provider network access facility, and wherein the at least one identity verification request includes a request for verifying the identity of the user of the mobile device.

2. The system of claim 1 wherein the at least one identity verification request further includes a request for verifying the identity of the merchant.

3. The system of claim 1 wherein the at least one identity verification request further includes a request for verifying credit card or billing information associated with the user of the mobile device.

4. An apparatus for use in a wireless cellular communication network having a transaction system for facilitating transactions with sellers of items or services, the apparatus comprising:
a short range communication facility;
a wireless transceiver for exchanging communications via the wireless cellular communication network; and
at least one processor coupled with the short-range communication facility and the wireless transceiver, wherein the at least one processor is configured for:
sending a purchase request to a seller subsystem via the short-range communication facility, the purchase request including identification information associated with an identity of a user of the mobile device;
receiving, from the transaction system, verification information for verifying the identity of the user of the mobile device, at least some of the verification information received via the wireless communication network; and
sending to the seller subsystem the verification information via the short-range communication facility.

5. The apparatus of claim 4 wherein the at least one processor is configured to receive, from a seller subsystem, information associated with an item or service that is a subject of a transaction.

6. The apparatus of claim 4 wherein the short-range communication facility is configured to transmit and receive information via Bluetooth.

7. The apparatus of claim 4 wherein the short-range communication facility is configured to transmit and receive information via Home RF.

8. The apparatus of claim 4 wherein the short-range communication facility includes a contactless smart card.

9. The apparatus of claim 4 wherein the short-range communication facility is configured to transmit and receive information via IrDA.

10. The apparatus of claim 4 wherein the short-range communication facility is configured to transmit and receive information via infrared.

11. The apparatus of claim 4 wherein the short-range communication facility is configured to transmit and receive information via IEEE 802.11.

12. The apparatus of claim 4 wherein the apparatus further includes a cryptography facility coupled to the at least one processor, the cryptography facility configured to digitally sign information prior to sending by the processor.

13. The apparatus of claim 4 wherein the apparatus further includes a locator facility coupled to the at least one processor, the locator facility configured to provide to the transaction system information associated with the location of the apparatus.

14. The apparatus of claim 4 wherein the processor is configured to send a request to the transaction system to authorize a transaction-related charge to an account associated with the apparatus.

15. A mobile apparatus for use in a cellular system for facilitating transactions with sellers of items or services, the mobile apparatus comprising:
a wireless transceiver for exchanging communications over the wireless cellular communication network; and
at least one processor coupled with the wireless transceiver, wherein the at least one processor is configured for:
sending a purchase request for use by a service provider subsystem associated with the mobile apparatus, the purchase request including identification information to be used by the service provider subsystem to verify an identity of a user associated with the mobile apparatus or to directly authorize a transaction associated with the purchase request;
based on the sent request, receiving verification information from the service provider subsystem, wherein the verification information verifies the identity of the user, and wherein the verification information is for use by a seller subsystem to conclude the purchase request.

16. The mobile apparatus of claim 15 further comprising, a display facility, wherein the display facility displays the received verification information to the seller subsystem to conclude the purchase request.

17. The mobile apparatus of claim 15 further comprising, a display facility, wherein the received verification information includes a displayable bar code symbol, and wherein the display subsystem displays the received verification information to the seller subsystem to conclude the purchase request.

18. The mobile apparatus of claim 15 wherein the at least one processor is further configured for receiving, from the seller subsystem, information associated with an item or service that is a subject of the transaction.

19. The mobile apparatus of claim 15 wherein the at least one processor is further configured for sending a transaction charge request to the service provider subsystem, the transaction charge request including an authorization for the service provider subsystem to charge an account of the user associated for an item or service that is a subject of a transaction.

20. The mobile apparatus of claim 15 wherein the at least one processor is further configured for sending a delivery request to the service provider subsystem, the delivery request including an authorization for the service provider subsystem to facilitate delivery of an item.

21. An apparatus for use in a wireless telephone network for facilitating a transaction between a wireless device and a seller of an item or service, the apparatus comprising:
a database storing at least a record associated with the wireless device; and
a server computer coupled to the database and the wireless telephone network, wherein the sever computer is configured to:
receive from a requesting facility a request to verify identity or authorize a commercial transaction, the request including identity information;
verify the received identity information by comparing the identity information with information stored in the database; and
where the identity information is verified, send to the requesting facility an indication that the identity information has been verified.

22. The apparatus of claim 21 wherein the requesting facility is a subsystem associated with the seller of an item or service.

23. The apparatus of claim 21 wherein the requesting facility is the mobile device.

24. The apparatus of claim 21 wherein the identity information includes a digital signature.

25. The apparatus of claim 21 wherein the requesting facility is a subsystem associated with the seller, wherein the identity information is associated with a user of the mobile device, and wherein server computer is further configured to send the indication that the identity information has been verified to the mobile device.

26. The apparatus of claim 21 wherein the requesting facility is the mobile device, wherein the identity information is associated with the seller, and wherein the server computer is further configured to send the indication that the identity information has been verified to a subsystem associated with the seller.

27. The apparatus of claim 21 wherein the requesting facility is the mobile device, wherein the identity information is associated with the mobile device, and wherein server computer is further configured to send the indication that the identity information has been verified to the subsystem associated with the seller.

28. The apparatus of claim 21 wherein the server computer includes a cryptography facility, and wherein the server computer is further configured to authenticate a digital signature of a user associated with the mobile device.

29. The apparatus of claim 21 wherein the server computer includes a cryptography facility, and wherein the server computer is further configured to authenticate a digital signature of the seller.

30. The apparatus of claim 21 wherein the server computer is further configured to verify an age of a user associated with the mobile device.

31. The apparatus of claim 21 wherein the server computer is further configured to verify an address of a user associated with the mobile device.

32. The apparatus of claim 21 wherein the server computer is further configured to verify a reputation of the seller.

33. The apparatus of claim 21 further comprising a locator facility, wherein the server computer is further configured to verify a location of the mobile device.

34. The apparatus of claim 21 wherein the server computer is further configured to provide an electronic time stamp, wherein the electronic time stamp provides an indication of a time that a transaction between the seller of an item or service and a user of the mobile device occurred.

35. The apparatus of claim 21 wherein the server computer includes a customer billing facility, and wherein the server computer is further configured to bill a user of a mobile device for a purchase of an item or service from the seller of an item or service.

36. The apparatus of claim 21 wherein the server computer is further configured to authorize charges to a third party financial service provider on behalf of a user of the mobile device.

37. The apparatus of claim 21 wherein the verified identity information is sent with a digital signature, and wherein the digital signature is associated with the apparatus.

38. The apparatus of claim 21 wherein the server computer is further configured to provide basic wireless communication service for the mobile device.

39. The apparatus of claim 21 wherein the server computer is further configured to receive service registration information from a user of the mobile device, the service registration information including instructions for providing basic wireless communication services and enhanced transaction-related service.

40. The apparatus of claim 21 wherein the server computer is further configured to receive and implement transaction parameters from a user of a mobile device, wherein the transaction parameters specify types and frequency of allowable transactions.

41. The apparatus of claim 21 wherein the identity information includes an account number associated with the mobile device.

42. The apparatus of claim 21 wherein the identity information includes an account number associated with a financial institution.

43. In a wireless cellular communication system, wherein the wireless cellular communication system includes one or more wireless devices and one or more server networks, a method of facilitating a transaction between a user of a mobile wireless device and a seller having a network device, the method comprising:
at the user's mobile wireless device, sending a purchase request containing information associated with a transaction, the request including information for identifying the user of the mobile wireless device with respect to the wireless cellular communication system;
at a server facility of the wireless cellular communication system, performing an authorization of the purchase request, wherein the authorization includes verifying an identity of the user of the mobile wireless device and providing an indication of the verification; and
at the seller's network device, consummating at least a part of the transaction based on the authorization.

44. The method of claim 43 wherein the purchase request is sent from the mobile wireless device to the seller's network device and from the seller's network device to the server facility of the wireless cellular communication system, and wherein the consummating at least a part of the transaction includes receiving a confirmation from the user.

45. The method of claim 43 wherein the purchase request is sent from the mobile wireless device to the server facility of the wireless cellular communication system, and wherein the consummating at least a part of the transaction includes receiving the provided indication from the server facility of the wireless cellular communication system.

46. The method of claim 43 wherein the purchase request is sent from the mobile wireless device to the server facility of the wireless cellular communication system, and wherein the consummating at least a part of the transaction includes receiving the provided indication from the mobile wireless device.

47. A computer-readable medium whose contents cause at least one server to perform a method to provide transaction-related services to users of mobile devices and sellers of items or services, the method comprising:
obtaining a request to purchase an item or service from a seller, wherein the request originates from a mobile device and wherein the request includes information identifying a user of the mobile device;
based on the obtained information identifying the user of the mobile device, verifying the identity of the user;
where the identity of the user is verified, generating an indication of the verification; and
sending the generated indication to the mobile device using a network connection.
